(19) United States
(12) Patent Application Publication
(10) Pub. No.: US 2005/0023028 A1
(43) Pub. Date: Feb. 3, 2005

(54) Cable including non-flammable micro-particles

(76) Inventor: William T. Clark, Lancaster, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 10/862,767

(22) Filed: Jun. 7, 2004

Related U.S. Application Data
(60) Provisional application No. 60/477,519, filed on Jun. 11, 2003.

(51) Int. Cl. H01B 11/02

(52) U.S. Cl. 174/113 R

(57) ABSTRACT

A data communication cable including a plurality of twisted pairs of insulated conductors, each twisted pair including two electrical conductors, each surrounded by an insulating layer and twisted together to form the twisted pair, and a jacket substantially enclosing the plurality of twisted pairs of insulating conductors, wherein the insulating layer includes a dielectric material including a plurality of micro-particles. In one example, the jacket material may also include a plurality of micro-particles. The micro-particles, in one example, are made of a non-burnable and/or non-smokeable material such as, for example, glass or ceramic.

### RELATED APPLICATIONS

This application claims priority under 35 U.S.C. § 119(e) to U.S. Provisional Application Ser. No. 60/477,519, entitled “DATA CABLE INCLUDING MICRO-PARTICLES,” filed on Jun. 11, 2003, which is herein incorporated by reference in its entirety.

### BACKGROUND OF INVENTION

1. 1. Field of Invention

The present invention is directed to cables employing non-burnable and/or non-smokeable materials, particularly to plenum-rated twisted pair cables using such materials for insulation and jacketing.

2. Discussion of Related Art

Buildings such as office buildings, apartments and other facilities designed for temperature regulation, often include an air space or plenum between the ceiling and floor of successive floors of the building. The plenum is often contiguous throughout the floor and permits warm or cool air to be circulated throughout the building to regulate temperature. Because plenums offer accessibility to the various parts of a building and due to the general convenience of air conduits that typically extend throughout a facility, cabling structures, for instance, the structured cabling of an office local area network (LAN), are often wired through the plenum.

Should a fire occur in, for example, an office building, the walls, insulation and other fire retardant material are often capable of containing the fire within some portion of the building. However, fires that reach the plenum tend to draft and spread to other parts of the building quickly, particularly when the plenum is employed for other purposes and contains flammable material. Unless the communication cables employed in the plenum are flame and/or smoke retardant, a fire that has breached the plenum may ignite the cabling structures which may spread smoke and fire throughout a building. This may quickly intensify and increase the severity of a fire, making it more likely that burn and/or asphyxiation injuries to the occupants of the building will result and increasing the damage that may be done to the building.

Accordingly, various fire codes and in particular the National Electric Code (NEC) prohibits the use of cables in the plenum unless they have been first tested and exhibit satisfactory smoke and fire retardation. The various requirements set forth by the NEC, often referred to generally as the plenum rating, may be satisfied in a series of burn tests provided by, for example, the Underwriters Laboratory (UL).

Plenum rated cables are often made from various fluoropolymer materials. For example, insulating layers formed around the individual wires of a cable are often made from a fluoroethylenepropylene (FEP) material and jackets formed about the cable may be made up of an ethylene tetra fluoroethylene copolymer (ETFE) compound. Other fluoropolymers such as polytetrafluoroethylene (PTFE) may be employed in plenum rated cables as well. Such fluoropolymers are known to generally exhibit smoke and fire retardation characteristics sufficient to pass the burn tests, for example, the “peak smoke” and “average smoke” requirements.

However, fluoropolymer materials are relatively expensive and increase the production costs of manufacturing plenum rated cables. In addition, although fluoropolymers may be generally flame and smoke retardant, under intense flame and/or heat conditions, fluoropolymers may burn and produce smoke.

### SUMMARY OF INVENTION

According to one embodiment, a data communication cable comprises a plurality of twisted pairs of insulated conductors, each twisted pair comprising two electrical conductors, each surrounded by an insulating layer and twisted together to form the twisted pair, and a jacket substantially enclosing the plurality of twisted pairs of insulating conductors, wherein the insulating layer includes a dielectric material comprising a plurality of micro-particles. In one example, the micro-particles may be glass or ceramic or another non-burnable and/or non-smokeable material.

In another example, the jacket may comprise a dielectric material including a second plurality of micro-particles, that may be mixed with the jacket material or embedded therein. The second plurality of micro-particles may be, for example, made of a non-burnable and/or non-smokeable material such as, but not limited to, glass or ceramic. In yet another example, the second plurality of micro-particles may be filled with a substance having at least one property that changes as function of thermal conditions of the cable. According to yet another example, the second plurality of micro-particles may filled with a substance having at least one property that changes as function of a frequency of electromagnetic signals propagating through the cable.

According to another embodiment, the cable may further comprise a separator disposed among the plurality of twisted pairs of insulated conductors. The separator may also comprise a material having a third plurality of micro-particles, which may be embedded therein or may be mixed with the separator material.

According to another embodiment, an insulated conductor comprises a conductor, an insulating layer surrounding the conductor so as to form the insulated conductor, the insulating layer comprising a dielectric material including a plurality of micro-particles, which may be embedded in the insulating layer or mixed with the material forming the insulating layer, wherein the plurality of micro-particles are made of at least one of a non-burnable material and a non-smokeable material. One or more twisted pairs may be made using such insulated conductors. These twisted pairs may, in turn, be used in a data communication cable.

### BRIEF DESCRIPTION OF DRAWINGS

The accompanying drawings, are not intended to be drawn to scale. In the drawings, each identical or nearly identical component that is illustrated in various figures is represented by a like numeral. For purposes of clarity, not every component may be labeled in every drawing. In the drawings:

FIG. 1 is a cross-sectional view of one embodiment of a cable according to aspects of the invention;

FIG. 2 is a cross-sectional view of another embodiment of a cable according to aspects of the invention; and

FIG. 3 is a cross-sectional view of another embodiment of a cable according to aspects of the invention.

### DETAILED DESCRIPTION

Various embodiments and aspects thereof will now be discussed in detail with reference to the accompanying figures. It is to be appreciated that this invention is not limited in its application to the details of construction and the arrangement of components set forth in the following description or illustrated in the drawings. The invention is capable of other embodiments and of being practiced or of being carried out in various ways. Examples of specific implementations are provided herein for illustrative purposes only. In particular, acts, elements and features discussed in connection with one embodiment are not intended to be excluded from a similar role in other embodiments. For example, the various compositions, arrangements and configurations of micro-particles described in any embodiment should be considered as contemplated for each of the embodiments described herein. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

In order to achieve plenum rated cables, manufacturers often employ materials that generally exhibit desirable burn and smoke characteristics such as, for example, any of various fluoropolymer compounds. However, such materials are often relatively expensive. Accordingly, the more of such material that is present in a cable, the higher the cost of manufacturing a plenum rated cable.

Applicants have identified of various methods of reducing or eliminating expensive compounds from data communications cables. For example, according to some embodiments, fluoropolymer material may be replaced in the cable by various less expensive materials that also have desirable flame and/or smoke characteristics, such that the cost of the cable may be reduced. In one example, the fluoropolymers used in conventional plenum cables may be replaced with non-burnable and/or non-smokeable materials. Such non-burnable and/or non-smokeable material may improve the burn characteristics of the cable over those manufactured with fluoropolymer material because the non-burnable and/or non-smokeable materials, respectively add no ignitable mass and do not produce smoke.

It is to be appreciated that for the purposes of this specification, the term “non-burnable” refers generally to materials that do not ignite in the presence of heat and/or flame. For example, materials (e.g., glass or ceramic) that tend to melt rather than burn or have essentially infinite flash points are considered as non-burnable material. The term “non-smokeable” refers generally to material that essentially produces no, or minimal (less than conventional “low-smoke” materials), smoke when exposed to heat, ignited and/or caused to change states.

In one embodiment, non-burnable and/or non-smokeable materials may be used in connection with fluoropolymer materials such that less fluoropolymer material is required to achieve the same or better burn characteristics as a conventional cable using only fluoropolymers. Alternatively, non-burnable and/or non-smokeable materials may be used in place of fluoropolymers to provide a relatively inexpensive plenum rated cable that meets or exceeds the burn characteristics of conventional plenum cables employing fluoropolymers.

Therefore, at least one embodiment of the present invention includes an electrical conductor, which may be, for example, a metal wire, a group of wires stranded together, a composite of metals, a fiber, or any other conductor used in the industry and known in the art. The electrical conductor may be surrounded by an insulating layer that includes a non-burnable and/or non-smokeable material, to form an insulated electrical conductor. According to one example, a plenum-rated data communications cable includes a plurality of insulated electrical conductors wherein the insulating material does not include any fluoropolymer material. In another example, a jacket of the plenum-rated cable may also not include any fluoropolymer materials. In yet another example, the jacket may include a non-burnable and/or non-smokeable material.

Applicant has identified and appreciated that micro-particles may be used to improve various characteristics of data communication cables. Micro-particles are small structures or shapes that may be added to another material to form a composite material, mixture or slurry. In one example, micro-particles used in embodiments of cables may have a diameter in a range of about 1 micrometer (μm) to about 300 μm. However, it is to be appreciated that the micro-particles may have other sizes and may be larger or smaller depending, for example, on the application for which they may be used. Micro-particles may be solid, hollow, partially hollow, porous or filled with other agents and/or materials, and may be of any general shape. Micro-particles may be shaped such that they form an empty micro-volume, cavity or void. Such a micro-volume may be open or closed or contain another agent, substance and/or material. Micro-particles may be mixed with or embedded in various materials and/or used as fillers in various compounds, colloids and/or mixtures.

For example, developments in materials have led to the production of various micro-particles, such as the micro-spheres manufactured by 3M, Emerson Cuming, Inc., and others. These glass micro-spheres, which may be made, for example, from sodium borosilicate, can be manufactured with desired dimensions and may be made hollow, solid, porous or filled. Micro-particles may be formed to different shapes other than spheres, however, spheres have generally desirable manufacturing properties. Micro-particles may be amalgamated into a single material or added to other materials, for example, as a filler in a mixture or slurry. It should be appreciated that micro-particles are not limited to the materials or vendors noted above and other micro-particles may be used in any of the embodiments described below.

Applicant has identified and appreciated that micro-particles may be included in various materials (e.g., thermoplastics) that are used to construct insulating layers, separators, binders, jackets and other components or portions of data communication cables. Applicants have further recognized that the addition of micro-particles formed from non-burnable and/or non-smokeable materials to cables may result in the cable having a variety of generally desirable properties including increased fire and smoke retardation, improved electrical characteristics, improved strength and weight characteristics, lower cost, and other advantages.

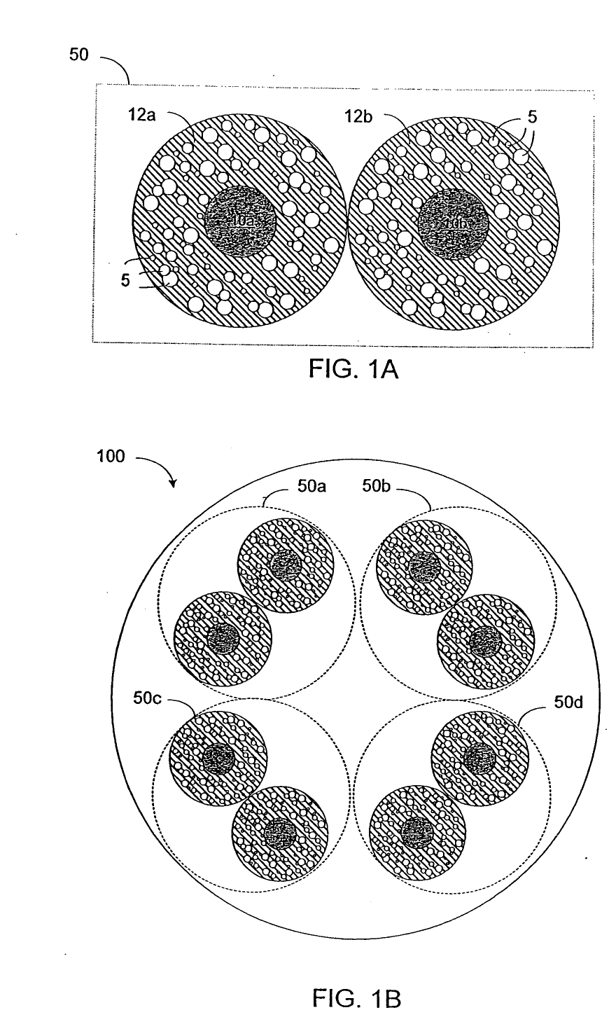

Referring to FIG. 1, there is illustrated a cross-sectional view of one embodiment of a cable according to aspects of the invention. The cable 100 includes four twisted pairs of insulated conductors 50a, 50b, 50c, 50d that may be bundled together and jacketed with a jacket 60. Each twisted pair 50 comprises two insulated conductors 52a, 52b. Each insulated conductor comprises an electrical conductor 54 surrounded by an insulating layer 56. It is to be appreciated that although FIG. 1 illustrates a cable including four twisted pairs of conductors, the invention is not so limited and the principles of the invention may be applied to cables having any number of twisted pairs. In addition, the principles of the invention are not limited to twisted pair cables and may be applied, for example, to cables using individual insulated conductors (as opposed to twisted pairs), optical cables, and the like. Also, in twisted pair cables, each twisted pair may be different from other twisted pairs in the cable (e.g., in terms of twist lay length, material used etc.), or some or all of the twisted pairs may be similar or the same.

According to one embodiment, the insulating layers 56 may be formed of a thermoplastic material having a plurality of micro-particles 70 distributed throughout the material. For example, micro-particles 70 may be glass or ceramic, or another non-burnable and/or non-smokeable material (such as, for example, diamond dust) that may be added as filler to the thermoplastic material before the material is extruded over the conductors to form insulating layers 56, or may be applied and/or provided in any other suitable way. For example, another way of providing a particle-impregnated layer may include providing a bath of ultraviolet-curable resin having micro-particles mixed with the resin and running an item to be coated (such as a conductor) through the bath prior to curing the resin.

While micro-particles 70 are illustrated in FIG. 1 as having a generally spherical shape, it should be appreciated that micro-particles may be formed to any desired shape or be of an arbitrary shape. For example, micro-particles may be shards of arbitrary or amorphous shape resulting from breaking, grinding, or other rendering a desired material into particulate matter. Moreover, micro-particles may be formed having micro-volumes or small cavities that are void, porous or contain air and/or other substances. For example, micro-particles 70 may include flame and/or smoke retardant materials such as carbon dioxide.

Micro-particles are not limited to non-burnable or non-smokeable material. For example, micro-particles may be formed from a flame and smoke retardant material such as any of various fluoropolymer compounds. Such fluoropolymer micro-particles may be embedded in, or mixed with, a less expensive material to achieve a reduced cost insulating layer having desirable burn characteristics.

In general, micro-particles may be provided in a number of ways to both improve the insulating layers resistance to flame and smoke and to facilitate forming a cable that can satisfy the various burn tests utilized by the UL in order to achieve a plenum rating. For example, non-burnable and/or non-smokeable micro-particles may reduce the amount of smoke producing material in a cable, improving the cables performance in peak and average smoke tests. Similarly, less expensive micro-particles having superior burn and smoke characteristics may reduce the amount of or eliminate altogether costly fluoropolymers conventionally used to provide a plenum rated cable. For example, the micro-particles may be used in connection with relatively inexpensive thermoplastic such as polyolefin to achieve satisfactory burn characteristics without having to resort to expensive fluoropolymer materials.

Certain electrical properties of a twisted pair may depend on the materials used in construction. For example, the characteristic impedance of a twisted pair is related to several parameters including the diameter of the conductors 54, the center-to-center distance between the conductors, the dielectric constant of insulating layers 56, etc. The center-to-center distance is proportional to the thickness of the insulating layers and the dielectric constant depends in part on the properties of the material. The micro-particles used in constructing the insulating layers may be chosen such that insulating layers achieve a desired effective dielectric constant. For instance, hollow or air-filled micro-particles may be embedded in a dielectric material forming the insulating layer, thereby lowering the effective dielectric constant of the insulating layer. The number of such micro-particles embedded in the insulating layer may be controlled so as to control the effective dielectric constant of the resulting composite (dielectric plus micro-particles) insulating layer material.

Accordingly, the dielectric constant may be reduced and/or tailored to meet the requirements of a particular design. Reduced dielectric constants for insulated conductors may yield higher transmission propagation speeds and have generally desirable skew characteristics. In general, it is to be appreciated that micro-particles may be used to tailor any characteristic of the cable, such as, but not limited to, characteristic impedance, burn characteristics, skew, crosstalk, etc.

It should be appreciated that various aspects of the present invention may be applied to other components of a data communication cable including, but not limited to, separators, binders, jackets, and the like. For example, many high performance cables employ some form of separator between the individual twisted pairs in a cable to further reduce crosstalk. Examples of such separators include, but are not limited to, cross-web separators and various configurable core separators that facilitate simple provision of any number of desirable arrangements available for separating twisted pairs or certain desired pairs in a multi-pair cable.

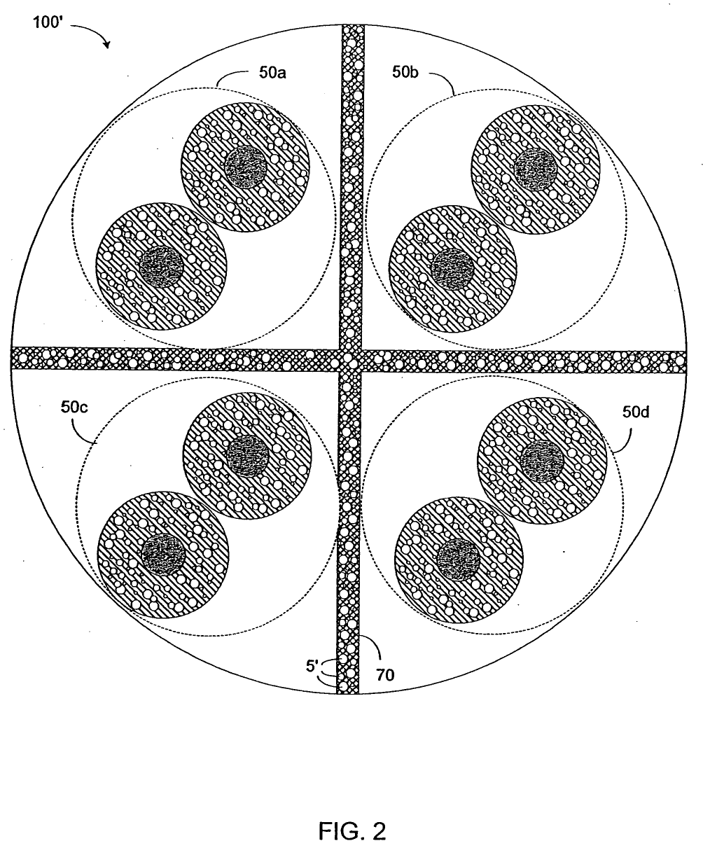

Referring to FIG. 2, there is illustrated another embodiment of a twisted pair cable 200 including a separator 202 that is disposed between the twisted pairs 204. In the illustrated example, each of the twisted pairs is separated from adjacent pairs by a flange of a cross or “+” shaped separator 202. However, it is to be appreciated that the separator 202 may have any of a variety of shapes and is not limited to a “+” shaped structure. In conventional plenum cables, separators are often made from relatively expensive fluoropolymer materials. In one embodiment, separator 202 may be made of any of various materials used in manufacturing separators, for example, a thermoplastic material. As shown, a plurality of micro-particles 206 are included in the material forming separator 202. As discussed above in connection with FIG. 1, the micro-particles may be of any shape and may comprise various flame and smoke resistant materials including glass, ceramic, fluoropolymers, etc. The micro-particles may comprise open or closed volumes and may contain other agents, for example, like flame retardant substances such as carbon dioxide.

According to one embodiment, illustrated in FIG. 2, the insulating layers 56 of the twisted pairs 204 may contain micro-particles 206. However, it should be appreciated that one, a plurality, or all of the twisted pairs 204 may be formed without micro-particles being in the insulating layers 56. Moreover, any of the various arrangements and compositions of micro-particles and materials described in connection with the insulators of FIG. 1 may be applied to any of various separators (e.g., separator 202) either individually or in combination with the insulators.

Thus, according to aspects of various embodiments, cables may be formed according to the invention using micro-particles 206 in all or any of the insulating layers 56 of the twisted pairs 204 and also optionally in the separator 202, in any combination. For example, the embodiment illustrated in FIG. 2 includes micro-particles in all of the insulating layers 56 and the separator 202. However, in another embodiment, for example, only one or two of the twisted pairs may have insulating layers including micro-particles and a separator may or may not include micro-particles.

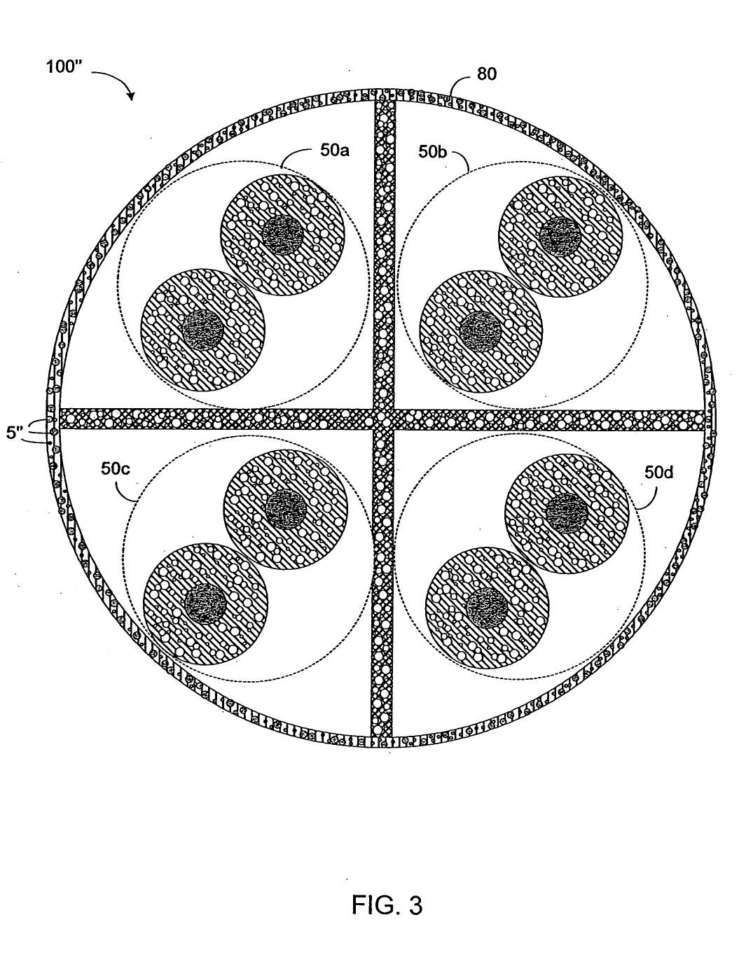

Referring to FIG. 3, there is illustrated another embodiment of a cable 300 according to aspects of the invention. The cable 300 includes a plurality of twisted pairs 302 that may be separated by a separator 202 and are held in place and proximate each other and the separator 202 by a jacket 302. Conventional plenum-rated cables often include jackets made from a flame and smoke retardant PVC material. According to one embodiment of the present invention, as illustrated in FIG. 3, the jacket 304 may be made to include a plurality of micro-particles 306 as part of, or embedded in or mixed with, the material forming the jacket 304. As discussed above, although the micro-particles 306 are illustrated as being generally spherical, they may be of any shape or structure including solid, hollow, porous, filled with another substance to reduce flame and/or smoke and may otherwise be arranged, composed and provided according to any of the various alternatives and methods described in the foregoing.

In addition, it is to be appreciated that in any embodiment, the micro-particles used in the jacket, the separator and the insulating layers may be the same or different shape, size and structure. For example, in one embodiment, all the micro-particles used in each of the jacket, separator and insulating layers may be solid glass or ceramic spheres or shards. In another embodiment, any or all of the insulating layers of the twisted pairs may include air-filled micro-particles while the separator may include solid glass micro-particles. It is to be appreciated that there are many possible variations of the type, number, shape etc., of micro-particles used in any of the insulating layers, the jacket and the separator. All of these possible variations are intended to be part of this invention and covered by this disclosure.

Referring again to FIG. 3, according to another aspect of the invention, the micro-particles 306 may be filled with a chemical or substance adapted to indicate at least one characteristic of the environment of the cable. For example, some of micro-particles 306 may include a chemical having a property (e.g., color) that changes as a function of ambient thermal conditions. Many PVC jackets are vulnerable to cracking when handled at low temperatures. Accordingly, a color change of the micro-particles may alert a cable installer that the temperature is too low to safely pull the cable and that the integrity of the cable may be at risk should it be twisted, bent, cornered or otherwise handled roughly.

According to another embodiment, some of micro-particles 306 may include substances that have a property (e.g., color) that changes as a function of the frequency of proximate electromagnetic radiation. Accordingly, the micro-particles may respond to the frequency of the data transmission of the cable as indication of the performance of the particular cable, or in response to radiation in the environment. In yet another embodiment, some of the micro-particles 306 may be filled with one type of chemical, for example that is able to indicate environmental conditions of the cable while others of the micro-particles 306 may be filled with substances that are adapted to indicate characteristics (such as frequency of data transmission) of the cable itself. Accordingly, so-called “smart-cables” can be adapted to be responsive both to internal and external operating characteristics of the environment.

Applicant has further appreciated that various testing, diagnostic and informational benefits may be derived by employing one or more light pipes within a cable. A light pipe refers generally to any light transmissive medium that facilitates the propagation of optical energy. For example, light pipes may be constructed from lucite, acrylic, optical fiber, etc.

According to one aspect of the invention, one or more light pipes are embedded into the jacket of a cable. Preferably, the light pipe would run or span the length of the cable such that light signals may be propagated, for example, from the source end of a cable to its termination. A light pipe may be produced as a cylindrical structure or may be provided as a generally planar material conformable to a surface of a cable such as, for example, the cable jacket. A light pipe may be employed in a cable as a device used to aid in identifying the cable. For example, in a structured cable system, the light pipe could be illuminated at its port in a network computer room or at its connection in a telecommunications closet so that it can be quickly and easily determined which cables are ultimately connected at which ports.

In addition, network failures or faulty connections may be easily identified and rectified by illuminating the problem node via its cable connection. Various other diagnostic and identification tasks may be achieved by the provision of a light pipe, such as tracing and general troubleshooting. Furthermore, the light pipe may be adapted to transmit information, for example, as a serial communications such that more sophisticated information may be relayed via the light pipe.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the scope of the invention. Accordingly, the foregoing description and drawings are by way of example only.

1. A data communication cable comprising:
a plurality of twisted pairs of insulated conductors, each twisted pair comprising two electrical conductors, each surrounded by an insulating layer and twisted together to form the twisted pair; and
a jacket substantially enclosing the plurality of twisted pairs of insulating conductors;
wherein the insulating layer includes a dielectric material comprising a plurality of micro-particles.

2. The data communication cable as claimed in claim 1, wherein the micro-particles are glass.

3. The data communication cable as claimed in claim 1, wherein the micro-particles are a ceramic material.

4. The data communication cable as claimed in claim 1, wherein the micro-particles are “diamond dust.”

5. The data communication cable as claimed in claim 1, wherein the plurality of micro-particles are embedded in the dielectric material

6. The data communication cable as claimed in claim 1, wherein the jacket comprises a dielectric material comprising a second plurality of micro-particles.

7. The data communication cable as claimed in claim 6, wherein the second plurality of micro-particles are made of glass.

8. The data communication cable as claimed in claim 6, wherein the second plurality of micro-particles are substantially spherical in shape.

9. The data communication cable as claimed in claim 6, wherein the second plurality of micro-particles are filled with a substance having at least one property that changes as function of thermal conditions of the cable.

10. The data communication cable as claimed in claim 6, wherein the second plurality of micro-particles are filled with a substance having at least one property that changes as function of a frequency of electromagnetic signals propagating through the cable.

11. The data communication cable as claimed in claim 1, further comprising a separator disposed among the plurality of twisted pairs of insulated conductors.

12. The data communication cable as claimed in claim 11, wherein the separator comprises a material having a third plurality of micro-particles disposed therein.

13. The data communication cable as claimed in claim 12, wherein the third plurality of micro-particles are embedded in the material of the separator.

14. The data communication cable as claimed in claim 1, wherein the plurality of micro-particles are arranged within the insulating layer so as to provide a desired effective dielectric constant of the insulating layer.

15. The data communication cable as claimed in claim 1, wherein the micro-particles comprise a non-burnable material.

16. The data communication cable as claimed in claim 1, wherein the micro-particles comprise a non-smokeable material.

17. An insulated conductor comprising:
a conductor;
an insulating layer surrounding the conductor so as to form the insulated conductor, the insulating layer comprising a dielectric material; and
a plurality of micro-particles disposed in the insulating layer;
wherein the plurality of micro-particles comprise at least one of a non-burnable material and a non-smokeable material.

17. The insulated conductor as claimed in claim 17, wherein the plurality of micro-particles comprise glass.

18. The insulated conductor as claimed in claim 17, wherein the plurality of micro-particles are embedded in the insulating layer.

19. A twisted pair of insulated conductors, comprising:
two insulated conductors helically twisted together about a common axis;
wherein each of the two insulated conductors are the insulated conductor as claimed in claim 16.

20. A data communication cable comprising:
a plurality of twisted pairs of insulated conductors;
wherein each of the plurality of twisted pairs of insulated conductors is the twisted pair as claimed in claim 20.

21. The data communication cable as claimed in claim 21, further comprising a jacket surrounding the plurality of twisted pairs of insulated conductors.

22. The data communication cable as claimed in claim 22, wherein the jacket comprises a material including a second plurality of micro-particles.

23. The data communication cable as claimed in claim 22, further comprising a light pipe disposed proximate a surface of jacket.

24. The data communication cable as claimed in claim 24, wherein the light pipe comprises a material that is conformable to the surface of the jacket.

25. The data communication cable as claimed in claim 24, wherein the light pipe has a predetermined color that serves to identify a characteristic of the data communication cable.

26. The data communication cable as claimed in claim 23, wherein the second plurality of micro-particles are filled with a substance having at least one property that changes as function of a temperature of the jacket.
